(19) United States
(12) Patent Application Publication
(10) Pub. No.: US 2019/0039268 A1
(43) Pub. Date: Feb. 7, 2019

(54) DEVICE AND METHOD FOR LOCALLY REINFORCING AND FORMING ELASTIC MOLD FOR MICRO-FLUIDIC CHIPS

(71) Applicant: GUANGDONG UNIVERSITY OF TECHNOLOGY, GUANGZHOU (CN)

(72) Inventors: Junfeng HE, GUANGZHOU (CN); Zhongning GUO, GUANGZHOU (CN); Ming WU, GUANGZHOU (CN); Chuanyun ZHANG, GUANGZHOU (CN); Xiaolei CHEN, GUANGZHOU (CN)

(21) Appl. No.: 16/153,774

(22) Filed: Oct. 7, 2018

Related U.S. Application Data
(63) Continuation of application No. PCT/CN2017/109068, filed on Nov. 2, 2017.

(30) Foreign Application Priority Data
Apr. 27, 2017 (CN) 201710287154.7
Apr. 27, 2017 (CN) 201720476596.1

(51) Int. Cl. B29C 33/38; B29C 33/50; B29C 33/42

(52) U.S. Cl. CPC B29C 33/3878; B29C 33/50; B82Y 40/00; B29C 33/3807; B29C 33/424

(57) ABSTRACT

A device and method for locally reinforcing and forming an elastic mold for micro-fluidic chips are provided. The device comprises a processing recess provided to a lathe, and a mold master pattern with a clamp installed in the processing recess through the mold master pattern clamp. The cathode of an electrophoresis auxiliary system is connected with a shaft of the lathe, and the output of the electrophoresis auxiliary system is simultaneously connected with the cathode and clamp of the mold master pattern, so that an auxiliary electric field can be formed between the mold master pattern and the cathode, so that a granular colloidal circulation system enables the mixed colloid produced by mixing reinforcing particles and filler colloid to deposit on the region to be reinforced of the elastic mold. A vacuum temperature control system is configured to heat and solidify the mixed colloid formed.

### CROSS-REFERENCE TO RELATED APPLICATIONS

This application is a continuation of international application PCT/CN2017/109068, filed Nov. 2, 2017, further claims priority to Chinese Patent Application No. 201710287154.7 and Chinese Patent Application No. 201720476596.1 both with a filing date of Apr. 27, 2017. The content of the aforementioned applications, including any intervening amendments thereto, are incorporated herein by reference.

### TECHNICAL FIELD

The disclosure relates to the technical field of elastic molds for micro-fluidic chips, and particularly relates to a device and method for locally reinforcing and forming an elastic mold for micro-fluidic chips.

### BACKGROUND OF THE PRESENT INVENTION

Nowadays, materials are applied to various fields for living and producing purposes. Different materials have different features and different application fields with increasing requirements on the quantity and quality. Non-metallic materials, as materials with excellent properties, have been widely used in various fields related to production processing. The non-metallic materials have in used to produce molds in industry due to their excellent properties in toughness, elasticity, plasticity etc. However, these properties just lead the molds have some defects in mechanical properties. Consequently, some post treatments are performed to the molds so as to meet the requirements on its strength, hardness, rigidity, wear resistance and other mechanical properties.

Microfluidics integrates basic operations, such as sample preparation, reaction, separation, and detection etc. in biological, chemical, and medical analysis processes, onto a micrometer-scale chip and automates the entire analysis process. Due to its great potential, microfluidics has become a new research field at the interaction of biology, chemistry, medicine, fluids, electronics, materials, machinery and so on. With the significant growth in the application of microfluidic chips, there is an urgent need for a fast, simple and cheap method for mass production of microfluidic devices of rigid polymer.

In view of all kinds of defects of rigid molds, the polydimethylsiloxane (PDMS) is commonly used to produce elastic molds, which are mostly applied in nanoscale imprinting at present. When applied in micron imprinting, the PDMS mold is easy to demold. However, the high aspect ratio structure will cause deformation during hot pressing and tearing during demold. Thus, it needs to increase the hardness of the elastic mold based keeping the elasticity of the mold so as to facilitate hot pressing and demolding of the high aspect ratio structure in micron imprinting.

At present, there are many methods for reinforcing the mechanical strength of PDMS, such as adding some fillers like inorganic nanoparticles, nano-clay, carbon nanotubes etc. into pure PDMS, and then solidifying and forming. Some scholars also add silicon alkoxides like TEOS into PDMS, and then different reactions will happen simultaneously, including solidification of PDMS, polymerization and hydrolysis of TEOS sol gel, and copolymerization to form polyurethane copolymer of PDMS. Although these methods can increase the strength of PDMS to a certain extent, the amplification increased is very limited and far from meeting the current demand.

### SUMMARY OF PRESENT INVENTION

Aiming at reinforcing the mechanical strength of a specific region to be reinforced, the present disclosure provides a device and method for locally reinforcing and forming an elastic mold for micro-fluidic chips based on electrophoresis-assisted method, in order to reinforce mechanical strength of the elastic mold and at the same time control the positions of the nanoparticles in local regions of the mold, and hence achieve hot pressing and nondestructive demolding of the high aspect-ratio, high depth-difference and large-area structure.

In one aspect, the device for locally reinforcing and forming an elastic mold is provide in the disclosure, which comprises: a lathe, a mold master pattern, a mold master pattern clamp for fixing the mold master pattern, a processing recess, a granular colloidal circulation system, an electrophoresis-assisted system and a vacuum temperature control system; the processing recess is provided to the lathe, and the mold master pattern is installed in the processing recess through the mold master pattern clamp; the electrophoresis-assisted system is connected with the lathe; the cathode of electrophoresis-assisted system is connected with a shaft of the lathe; an output of electrophoresis-assisted system is simultaneously connected with the cathode and the mold master pattern clamp, so that an auxiliary electric field can be formed between the mold master pattern and the cathode, the granular colloidal circulation system is configured to mix reinforcing particles and filler colloid to form mixed colloid, the auxiliary electric field ensures orientated deposition of the mixed colloid in a region to be reinforced on the mold master pattern to form the elastic mold, and the mixed colloid will be heated and solidified by the vacuum temperature control system.

Advantageously, the device further comprises an online video monitoring system provided to the lathe for real-time monitoring the mixed colloid on a surface of the mold master pattern.

Advantageously, the online video monitoring system is a charge-coupled device (CCD) digital microscope.

Advantageously, the device further comprises an auxiliary colloid shaping cavity for limiting a flow direction of the mixed colloid on the surface of mold master pattern.

Advantageously, the device further comprises a 3D motion platform provided to the lathe, the processing recess is mounted on the 3D motion platform, and the 3D motion platform is configured to precisely control a moving direction of the processing recess.

Advantageously, the device further comprises a straw clamp connected to the shaft, and configured to draw the mixed colloid produced by the granular colloidal circulation system to the surface of the mold master pattern.

Advantageously, the granular colloidal circulation system comprises a dilution module, a mixed colloid drainage module, a solution circulation module, an ultrasonic vibration module, a magnetic stirring module and a colloidal circulation module, for diluting, and thoroughly mixing desired nanoparticles or fillers with the mixed colloid, and filtering and recycling the mixed colloid.

Advantageously, the device further comprises an integrated control cabinet simultaneously connected with the lathe, the granular colloidal circulation system, the electrophoresis auxiliary system and the vacuum temperature control system so as to control operating states of the lathe, the granular colloidal circulation system, the electrophoresis auxiliary system and the vacuum temperature control system.

In another aspect, the present disclosure further provides a method for locally reinforcing and forming an elastic mold for micro-fluidic chips, which comprises following steps:

S1: uniformly mixing reinforcing particles or fillers with colloid to form mixed colloid;

S2: performing orientated deposition of the mixed colloid in an auxiliary electric field formed between a mold master pattern and a cathode of an electrophoresis auxiliary system to form an elastic mold;

S3: vacuum heating and solidifying the formed elastic mold.

Advantageously, the step S2 comprises: the orientated deposition of the mixed colloid is performed in an auxiliary colloid shaping cavity to form the elastic mold.

Compared with the prior art, the method and device according to the present invention have the following advantageous:

In the device and method according to the disclosure, the auxiliary electric field formed between the mold master pattern and the cathode enables the nanoparticles in the mixed colloid to be orientately deposited in elastic mold, which improves the mechanical strength of the elastic mold and controls at the same time the reinforcing position of the nanoparticles in the mold. Namely, the reinforced colloid is transferred to certain region to be reinforced, so as to reinforce the mechanical strength of the region.

### DESCRIPTION OF THE DRAWINGS

In order to make the technical solutions in the disclosure described more clearly, the drawings associated to the description of the embodiments or the prior art will be illustrated concisely in the following. Obviously, the drawings described below are only some embodiments according to the disclosure. It is appreciated that more drawings will be obtained by one of ordinary skill in the art based on the drawings described in the disclosure without paying any creative work.

FIG. 1 is a structural schematic diagram of an device for locally reinforcing and forming an elastic mold for micro-fluidic chips according to an embodiment of this disclosure;

FIG. 2 is a flow chart of a method for locally reinforcing and forming the elastic mold for micro-fluidic chips according to an embodiment of the disclosure;

FIG. 3 is a schematic diagram showing process for locally reinforcing and forming the elastic mold according to an embodiment of the disclosure;

FIG. 4 is a structural diagram showing a granular colloidal circulation system according to an embodiment of the disclosure; and

FIG. 5 is a structural diagram showing a mold master pattern clamp according to an embodiment of the disclosure.

### DETAILED DESCRIPTION OF PREFERRED EMBODIMENTS

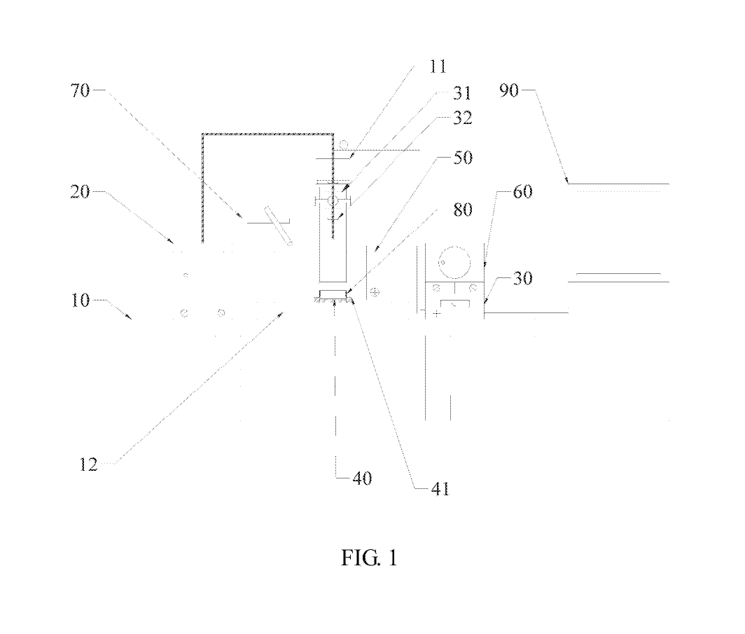

The present disclosure will now be described more clearly and fully with reference to the accompanying drawings, in which exemplary embodiments of the disclosure are shown. This disclosure may, however, be embodied in many different forms and should not be construed as limited to the embodiments set forth herein. It is appreciated that more embodiments will be obtained by one of ordinary skill in the art based on the embodiments described herein without paying any creative work. Referring to FIGS. 1, 3 and 5, the device for locally reinforcing and forming an elastic mold for micro-fluidic chips according to one embodiment, comprises: a lathe 10, a granular colloidal circulation system 20, an electrophoresis-assisted system 30, a mold master pattern 40, a processing recess 50 and a vacuum temperature control system 60. The processing recess 50 is provided to the lathe 10, and the mold master pattern 40 is mounted within the processing recess 50 through the mold master pattern clamp 41. A cathode 32 of the electrophoresis-assisted system 30 is connected with a shaft 11 of the lathe 10, and an output of electrophoresis-assisted system 30 is simultaneously connected with the cathode 32 and the mold master pattern clamp 41, for forming an auxiliary electric field between the mold master pattern 40 and the cathode 32, the granular colloidal circulation system 20 is configured to mix reinforcing particles 102 and filler colloid 104 to form mixed colloid, the auxiliary electric field ensures orientated deposition of the mixed colloid in a region to be reinforced to form the elastic mold, and then the mixed colloid will be heated and solidified by vacuum temperature control system 60.

The functions of the vacuum temperature control system 60 include heating the colloid formed after orientated deposition in the region to be reinforced of the elastic mold, adjusting the vacuum degree and temperature of the space where the vacuum temperature control system 60 locates and controlling the environment during the entire process.

The electrophoresis-assisted system 30 is capable of forming a controllable and effective electric field between the mold master pattern 40 in the processing recess 50 and the cathode 32 and switching between the positive and negative DC and AC electric field while processing.

The formation of the auxiliary electric field realizes the orientated deposition of nanoparticles in the mixed colloid, which improves the mechanical strength of the elastic mold and at the same time controls the reinforcing position of the nanoparticles 102 in the mold, so as to achieve the objective of increasing the mechanical strength of a specific region.

It should be noted that the elastic molds described in this disclosure are not specifically limited, and it may be a PDMS elastic mold or other suitable elastic molds.

During the operation, the granular colloid circulation system 20 mixes the reinforcing particles 102 and the filler colloid 104 to produce a mixed colloid first, and then the mixed colloid is output to the mold master pattern 40 in the processing recess 50. The mold master pattern 40 is fixed by the mold master pattern clamp 41. The output of the electrophoresis-assisted system 30 is connected with the cathode 32 and the clamp 41 of the mold master pattern 40 for forming the auxiliary electric field between the mold master pattern 40 and the cathode 32, so that the mixed colloid is orientately deposited in the specific region to be reinforced 43. The output of the electrophoresis-assisted system 30 is capable of controlling the auxiliary electric field formed and controlling the reinforcing position of the nanoparticles 102 in the mixed colloid in the elastic mold while the mechanical strength of the elastic mold is increased, and hence achieving the objective of increasing the mechanical strength of the specific region.

In order to further improve the quality of the orientated deposition and obtain the detailed situation and distribution in the elastic mold for real-time, the devise further comprises an online video monitoring system 70 provided to the lathe 10 for real time monitoring the mixed colloid on the surface of the mold master pattern 40 so as to obtain in real time the deposition state and particle distribution of the nanoparticles or fillers in the mixed colloid in the elastic mold.

In the embodiment, the online video monitoring system 70 is a CCD digital microscope, which improves the resolution and accuracy when monitoring the detailed deposition state and particle distribution of nanoparticles or other fillers in the elastic mold. The online video monitoring system 70 mentioned in the disclosure is not specifically limited.

In order to further improve the efficiency of deposition, the device according to the disclosure further comprises an auxiliary colloid shaping cavity 80 arranged in the processing recess 50 for limiting a flow direction of the mixed colloid on the surface of mold master pattern 40. With the auxiliary colloid shaping cavity 80, the flow direction of the mixed colloid will be limited during the processing, so as to ensure the mixed colloid reach the destination as quick as possible. Thus the efficiency and quality of deposition are improved, the processing time is reduced, and molds with different shapes may be produced. In the present disclosure, the shaft 11 of the lathe 10 are movable up and down, and the cathodes of the electrophoresis auxiliary system 30 with different shapes are provided to the shaft 11 and are switchable on line. The cathode is capable of applying a certain pressure to the colloid, so that the colloid is uniformly distributed in the auxiliary colloid shaping cavity 80.

The mold master pattern clamp 41 for fixing the mold master pattern 40 is fixed in the processing recess 50. It is capable of process the elastic molds with different shapes through mounting mold master patterns with different shapes and sizes.

The processing recess 50 needs to move during the processing in order to process the mixed colloid deposited in the elastic mold. The device according to the disclosure further comprises a 3D motion platform 12 provided to the lathe 10, so as to ensure the movement of the processing recess 50 more precise and the orientated deposition of the mixed colloid more precise. The processing recess 50 is installed on the 3D motion platform 12. The 3D motion platform 12 is configured to control a moving direction of the processing recess 50 precisely ensure a relative position between the processing recess 50 and the shaft 11, ensure the mixed colloid to reach the specific region to be reinforced precisely before processing the mixed colloid, reduce system error and improve reinforcing accuracy.

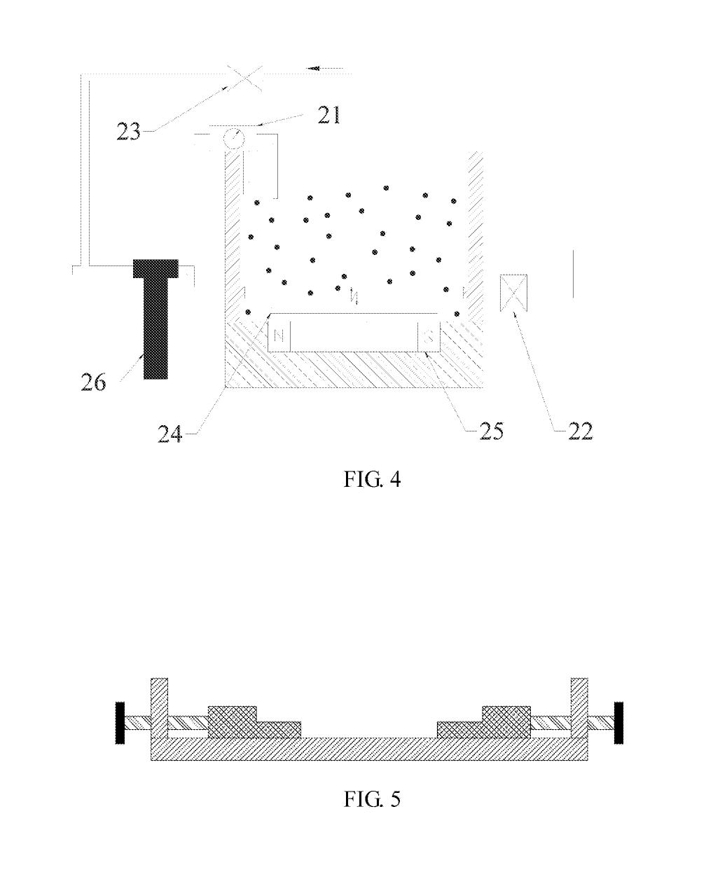

In the present disclosure, the granular colloidal circulation system 20 is configured to thoroughly mix the reinforcing particles 102 and filler colloid 104 to form the mixed colloid and ensure the uniform distribution of the mixed colloid. As shown in FIG. 4, the granular colloidal circulation system 20 comprises a dilution module 21, a mixed colloidal drainage module 22, a solution circulation module 23, an ultrasonic vibration module 24, a magnetic stirring module 25, and a colloidal circulation module 26 for diluting, and thoroughly mixing desired nanoparticles or fillers with the mixed colloid, and filtering and recycling the mixed colloid. The dilution module 21 is configured to adjust the concentration of reinforcing particles and fillers mixed together since the pure reinforcing particles can't be used to reinforce the elastic mold directly. The desired nanoparticles 102 or fillers with solution 104 are mixed in the granular colloidal circulation system 20 to form the mixed colloid. The ultrasonic vibration module 24 and the magnetic stirring module 25 are configured to stir during the forming of the mixed colloid so as to accelerate the forming of the mixed colloid, improve the uniformity of the mixed colloid, shorten the formation cycle, and ensure particles with the same or different types blend in with the colloid. The solution circulation module 23 is configured to reuses the residual solution during the formation of the mixed colloid so as to increase the utilization of the solution. The colloidal circulation module 26 is configured to filter and recycle the colloid for improving the utilization of colloid. The mixed colloid drainage module 22 is configured to output the mixed colloid from the granular colloidal circulation system 20.

In the embodiment according to the disclosure, the shaft 11 of the lathe 10 is combined with the granular colloidal circulation system 20, which enables the mixed colloid drawn from the granular colloidal circulation system 20 to the surface of mold mater pattern 40 once or more times through a straw clamp 31 connected to the shaft 11. The shaft 11 of the lathe 10 is further combined with a cathode clamp of the electrophoresis-assisted system and can switch between different cathodes so as to form electrophoresis-assisted electric field with different workpieces and hence realize electrophoresis-assisted deposition. Accordingly, the device may further comprises the straw clamp 31 connected with the shaft 11 of the lathe 10 and configured to draw the mixed colloid produced by the granular colloidal circulation system 20 to the surface of the mold master pattern 40.

In order to realize unified management, save space, and simplify operation, the device according to the disclosure further comprises an integrated control cabinet 90 simultaneously connected with the lathe 10, the granular colloidal circulation system 20, the electrophoresis auxiliary system 30 and the vacuum temperature control system 60, so as to control operating states of the lathe 10, the granular colloidal circulation system 20, the electrophoresis auxiliary system 30 and the vacuum temperature control system 60. The integrated control cabinet 90 integrates the control programs for all the systems to ensure the successful operation of all the processes. The operator could monitor the working status of all the systems by setting the operational parameter on the integrated control cabinet 90.

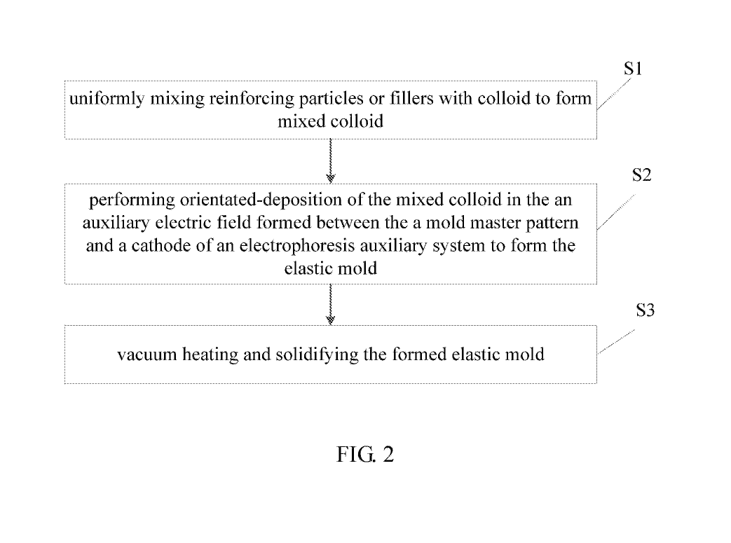

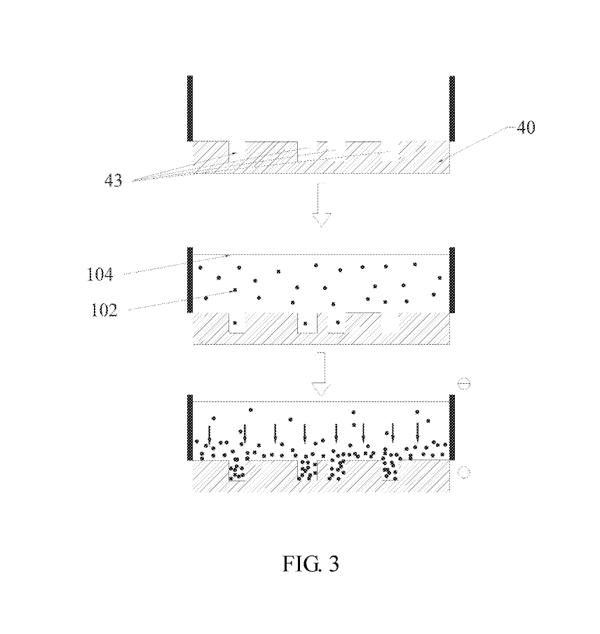

In addition, as shown in FIGS. 2 and 3, the present disclosure further provides a method for locally reinforcing and forming an elastic mold for microfluidic chips, which comprises following steps:

S1: uniformly mixing reinforcing particles or fillers with colloid to form a mixed colloid with a preset concentration so as to avoid the concentration of the reinforcing particles at the reinforced region being too low or too high and ensure the effect of reinforcement in mechanical strength;

S2: performing an orientated deposition of the mixed colloid in the auxiliary electric field formed between the mold master pattern and the cathode of the electrophoresis auxiliary system to form the elastic mold; wherein the mixed colloid is controlled to deposit on the region that needs to be reinforced through the orientated deposition of the mixed colloid in the elastic mold, and the reinforcing particles are capable of reaching the preset region to be reinforced to facilitate reinforcement to the specific region to be reinforced; and

S3: vacuum heating and solidifying the formed elastic mold. The heating and solidifying process to the formed elastic mold is needed since the elastic mold has not solidified after the deposition of the mixed colloid in the region to be reinforced and cannot be used directly. The parameters of the heating temperature, the vacuum degree and the heating time are not specifically limited in the present disclosure.

In order to further improve the deposition efficiency of the mixed colloid, the step S2 includes performing the orientated deposition of mixed colloid in the auxiliary colloid shaping cavity, which limits a flow direction of the mixed colloid and accelerates the production of elastic molds with various shapes.

In summary, the device and method for locally reinforcing and forming the elastic mold for micro-fluidic chips provided in the disclosed, draws the reinforcing particles in mixed colloid to a specific region that needs to be reinforced under the assistance of the auxiliary electric field formed between the mold master pattern and the cathode, and realizes the orientated deposition of nanoparticles of the mixed colloid in elastic mold, so as to achieve locally reinforcing and forming of the elastic mold. The reinforcing position of the nanoparticles in the mold can be controlled while the mechanical strength of the elastic mold is reinforced, so as to achieve the objective of locally improving mechanical strength of the specific region.

The device and method for locally reinforcing and forming the elastic mold for micro-fluidic chips in the disclosure have been detailed described above. The principle and implementation of the present invention have illustrated by way of exemplary embodiments so that the method and key concept will be fully conveyed to those skilled in the art. it is appreciated that various improvements and modifications may obtained by those skilled in the art without departing from the principle of this disclosure, and all these improvements and modifications fall into the scope of the appended claims.

We claim:

1. A device for locally reinforcing and forming an elastic mold for micro-fluidic chips, comprising: a lathe, a granular colloidal circulation system connected to the lathe, an electrophoresis auxiliary system, a mold master pattern, a mold master pattern clamp configured to fix the mold master pattern, a processing recess and a vacuum temperature control system, wherein the processing recess is provided to the lathe, and the mold master pattern is installed in the processing recess through the mold master pattern clamp, a cathode of the electrophoresis auxiliary system is connected with a shaft of the lathe, an output of the electrophoresis assistance system is connected with the cathode and the mold master pattern clamp for forming an auxiliary electric field between the mold master pattern and the cathode, the granular colloidal circulation system is configured to mix reinforcing particles and filler colloid to form mixed colloid, the auxiliary electric field ensures orientated deposition of the mixed colloid in a region to be reinforced on the mold master pattern to form the elastic mold, and the vacuum temperature control system is configured to heat and solidify the mixed colloid formed.

2. The device according to claim 1, further comprising an online video monitoring system provided to the lathe for real-time monitoring the mixed colloid on a surface of the mold master pattern.

3. The device according to claim 2, wherein the online video monitoring system is a CCD digital microscope.

4. The device according to claim 3, further comprising an auxiliary colloid shaping cavity for limiting a flow direction of the mixed colloid on the surface of mold master pattern.

5. The device according to claim 4, further comprising a 3D motion platform provided to the lathe, wherein the processing recess is mounted on the 3D motion platform, and the 3D motion platform is configured to precisely control a moving direction of the processing recess.

6. The device according to claim 5, further comprising a straw clamp connected to the shaft, and configured to draw the mixed colloid produced by the granular colloidal circulation system to the surface of the mold master pattern.

7. The device according to claim 6, wherein the granular colloidal circulation system comprises a dilution module, a mixed colloid drainage module, a solution circulation module, an ultrasonic vibration module, a magnetic stirring module and a colloidal circulation module, for diluting, and thoroughly mixing desired nanoparticles or fillers with the mixed colloid, and filtering and recycling the mixed colloid.

8. The device according to claim 7, further comprising an integrated control cabinet simultaneously connected with the lathe, the granular colloidal circulation system, the electrophoresis auxiliary system and the vacuum temperature control system so as to control operating states of the lathe, the granular colloidal circulation system, the electrophoresis auxiliary system and the vacuum temperature control system.

9. A method for locally reinforcing and forming an elastic mold for micro-fluidic chips, comprising the following steps:
S1: uniformly mixing reinforcing particles or fillers with colloid to form mixed colloid;
S2: performing orientated deposition of the mixed colloid in an auxiliary electric field formed between a mold master pattern and a cathode of an electrophoresis auxiliary system to form the elastic mold;
S3: vacuum heating and solidifying the formed elastic mold.

10. The method according to claim 9, wherein the step S2 comprises: performing the orientated deposition of the mixed colloid in an auxiliary colloid shaping cavity to form the elastic mold.
